(19) United States
(12) Patent Application Publication
(10) Pub. No.: US 2024/0273448 A1
(43) Pub. Date: Aug. 15, 2024

(54) INFORMATION EQUIPMENT AND DISPLAY METHOD

(71) Applicant: TOYOTA JIDOSHA KABUSHIKI KAISHA, Toyota-shi (JP)

(72) Inventors: Kanako AIDA, Inuyama-shi (JP); Sayumi MIYAZAKI, Inazawa-shi (JP); Izumi SUGIYAMA, Nagoya-shi (JP); Koki KAWAMURA, Nagoya-shi (JP); Yohei KOIKE, Nagoya-shi (JP); Koji NISHI, Nagoya-shi (JP); Atsushi SAJIKI, Okazaki-shi (JP)

(73) Assignee: TOYOTA JIDOSHA KABUSHIKI KAISHA, Toyota-shi (JP)

(21) Appl. No.: 18/435,157

(22) Filed: Feb. 7, 2024

(30) Foreign Application Priority Data
Feb. 15, 2023 (JP) 2023-021454

(51) Int. Cl. G06Q 10/067

(52) U.S. Cl. CPC G06Q 10/067

(57) ABSTRACT

The processor displays, in a normal form, information of the first store operated by the first business whose social contribution level has been determined not to reach a predetermined standard, and whose social contribution level has been determined to have reached a predetermined standard. The display is controlled so as to display the information of the second store operated by the second business in a more emphasized form than in the first form.

### CROSS-REFERENCE TO RELATED APPLICATION

This application claims priority to Japanese Patent Application No. 2023-021454 filed on Feb. 15, 2023 incorporated herein by reference in its entirety.

### BACKGROUND

### 1. Technical Field

The present disclosure relates to information equipment and a display method.

### 2. Description of Related Art

In recent years, there is demand for businesses to contribute to society by actively reducing environmental impact, such as represented in Sustainable Development Goals (SDGs) related activities. On the other hand, there are users who want to actively contribute to society on an individual level as well. There are needs, regarding such users, wanting to purchase products or services from stores operated by businesses that have a high social contribution level.

For example, Japanese Unexamined Patent Application Publication No. 2002-352152 (JP 2002-352152 A) describes technology for determining, when a purchaser purchases a product or the like, a contribution monetary amount to go to an non-profit organization (NPO) with respect to a business operator with a high awareness of social contribution, who has agreed to contribute to the NPO. Further, Japanese Unexamined Patent Application Publication No. 2009-093566 (JP 2009-093566 A) describes a technique of quantifying social contribution levels (see paragraph [0023]).

### SUMMARY

While appropriately connecting businesses with a high social contribution level with users who want to contribute to society is desirable, there is still room for improvement in terms of how to connect businesses and users.

The present disclosure has been made in order to solve the above problem, and an object of the present disclosure is to provide information equipment and a display method that can meet the needs of users who want to actively use stores operated by businesses with a high social contribution level.

(1) Information equipment according to a first aspect of the present disclosure includes a display and a control device. The display is configured to display information of a store operated by a business. The control device controls the display. The control device controls the display to display information of a first store operated by a first business of which a social contribution level does not attain a predetermined standard in a first form, and to display information of a second store operated by a second business of which the social contribution level attains the predetermined standard in a second form that is more emphasized than the first form.

In the configuration according to (1) above, information of stores operated by businesses of which the social contribution level attains a predetermined standard is displayed in a form that is more emphasized than information of stores operated by businesses of which the social contribution level does not attain the predetermined standard, and accordingly users can acquire information of stores operated by businesses that have a high social contribution level more readily. Thus, the needs of users who want to actively use stores operated by businesses with a high social contribution level can be met.

(2) The information of the first store includes a first coupon image that can be used at the first store. The information of the second store includes a second coupon image that can be used at the second store.

According to the above configuration (2), coupons that can be used at stores operated by businesses with high social contribution levels are displayed emphasized, and accordingly the needs of users who want to actively use stores operated by businesses with a high social contribution level can be met through the users using these coupons.

(3) The first form is a form in which a mark image, indicating that the social contribution level is high, is not added to the first coupon image. The second form is a form in which the mark image is added to the second coupon image.

According to the above configuration (3), whether the store is operated by a business that has a high social contribution level can be identified from the coupon.

(4) Determination of whether the social contribution level attains the predetermined standard is made based on a numerical value obtained by quantizing the social contribution level, and a category of the business.

According to the above configuration (4), the standard for whether a business has a high social contribution level can be changed for business category.

(5) A display method according to a second aspect of the present disclosure is a method of displaying information of a store operated by a business. The display method includes displaying the information of the store on a display of information equipment. The displaying includes displaying information of a first store operated by a first business of which a social contribution level does not attain a predetermined standard in a first form, and displaying information of a second store operated by a second business of which the social contribution level attains the predetermined standard in a second form that is more emphasized than the first form.

According to the method of (5) above, as with the configuration (1) above, the needs of users who want to actively use stores operated by businesses with a high social contribution level can be met.

According to the present disclosure, the needs of users who want to actively use stores operated by businesses with a high social contribution level can be met.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the overall configuration of a management system according to an embodiment of the present disclosure;

FIG. 2 is a diagram showing an example of a server configuration;

FIG. 3 is a diagram showing an example of the configuration of a terminal;

FIG. 4 is a diagram showing an example of a social contribution level DB;

FIG. 5 is a diagram showing an example of a display form of a terminal display; and

FIG. 6 is a flowchart showing an example of the processing procedure of display processing according to the present embodiment.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### System Configuration

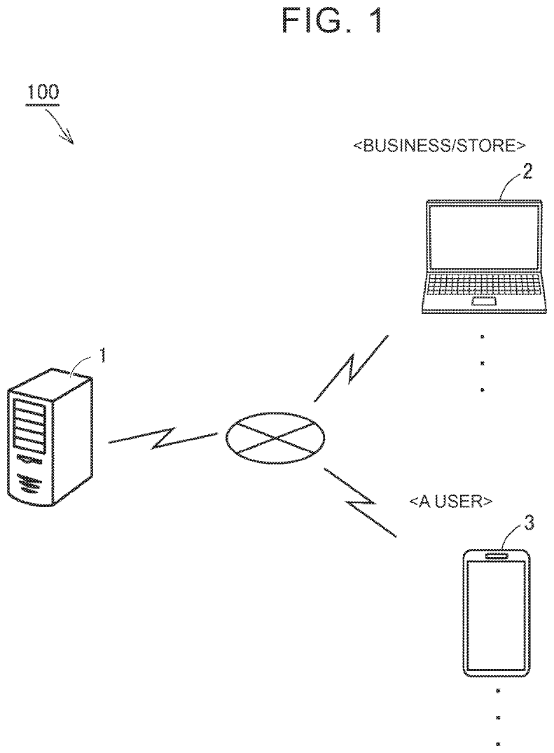

FIG. 1 is a diagram schematically showing the overall configuration of a management system 100 according to an embodiment of the present disclosure. The management system 100 includes a server 1, multiple terminals 2, and multiple terminals 3. The management system 100 is a system for managing information (offering of coupons, etc.) of stores operated by businesses.

The terminal 2 is a terminal used by each of a plurality of businesses or a plurality of stores operated by a plurality of businesses. The terminal 3 is a terminal carried by each of a plurality of users who use these stores. The terminal 3 corresponds to an example of the “information equipment” of the present disclosure.

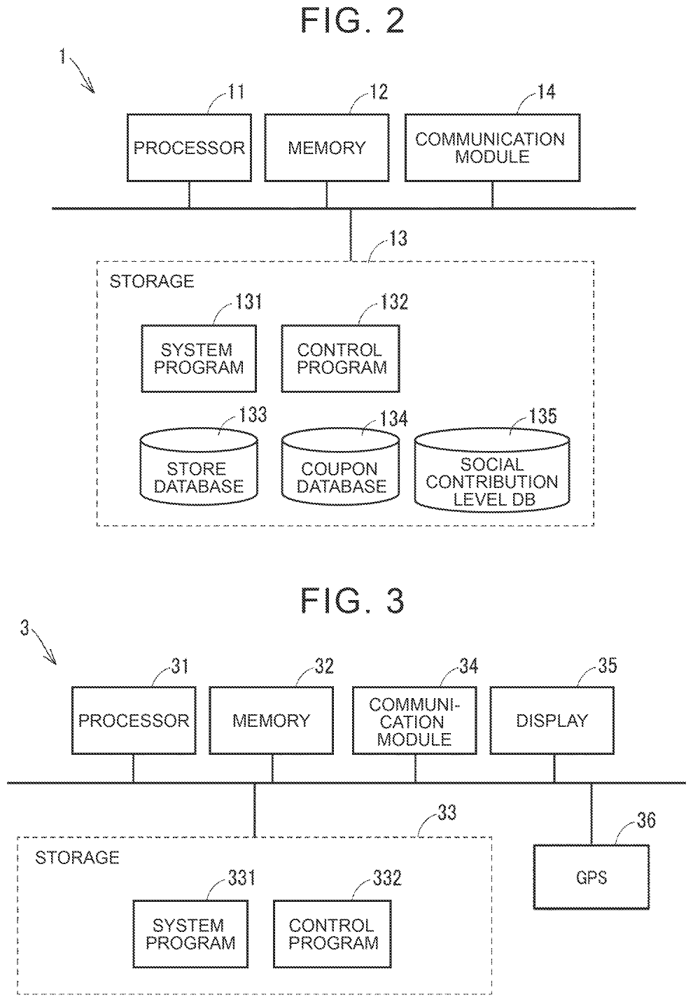

FIG. 2 is a diagram showing an example of the configuration of the server 1. Server 1 includes, for example, processor 11, memory 12, storage 13 and communication module 14.

The processor 11 is, for example, a microprocessor such as a Central Processing Unit (CPU) or Micro-Processing Unit (MPU). Memory 12 is a volatile memory such as Random Access Memory (RAM). The processor 11 implements various processes by reading out the system program 131 and the control program 132, developing them in the memory 12, and executing them.

The storage 13 is a rewritable nonvolatile memory such as a Hard Disk Drive (HDD), Solid State Drive (SDD), flash memory, or the like. The storage 13 contains a system program 131 including an operating system (OS), a control program 132 including computer-readable code necessary for control calculations, a store database (DB) 133, a coupon database (DB) 134, a social contribution level database (DB) 135 is stored. The store DB 133, coupon DB 134 and social contribution level DB 135 will be described later.

Communication module 14 includes a communication interface with a network such as the Internet. The communication module 14 is configured to allow two-way communication with external devices of the server 1 (a plurality of terminals 2, a plurality of terminals 3, etc.).

FIG. 3 is a diagram showing an example of the configuration of the terminal 3. Terminals 3 used by users who use the store are, for example, smart phones, tablets, and smart watches. Terminal 3 may be a notebook Personal Computer (PC). Terminal 3 includes, for example, processor 31, memory 32, storage 33, communication module 34, display 35 and Global Positioning System (GPS) 36.

Processor 31 is, for example, a microprocessor such as a CPU or MPU. The memory 32 is a volatile memory such as RAM. The processor 31 implements various processes by reading out the system program 331 and the control program 332, developing them in the memory 32, and executing them. The processor 31 corresponds to an example of the “control device” of the present disclosure. Note that the processor 31 may include the memory 32 and the like to form a control device.

The storage 33 is a rewritable non-volatile memory such as flash memory. The storage 33 stores a system program 331 including an OS and a control program 332 including computer-readable code required for control calculations.

Communication module 34 includes a communication interface conforming to wireless communication standards. The wireless communication standard may be Long Term Evolution (LTE) such as 4G, 5G, or a wireless Local Area Network (LAN) such as Wireless Fidelity (Wi-Fi), or both. There may be. The communication module 34 is configured to allow two-way communication with the server 1.

The display 35 is a mobile display such as organic Electro Luminescence (EL) or liquid crystal. The display 35 is configured to display various information according to control commands from the processor 31. In this example, the display 35 is a display with a touch panel capable of accepting user input operations.

The GPS 36 acquires information (GPS information) indicating the current position of the terminal 3 based on signals from a plurality of satellites, and outputs the GPS information to the processor 31. Note that terminal 3 may include a beacon receiver (not shown) instead of or in addition to GPS 36.

A control program 332 (application software) for displaying store and coupon information is installed in the terminal 3. The user can display store and coupon information by operating the terminal 3.

A terminal 2 used by a business or store is, for example, a laptop PC, but may be a tablet, a smart phone, or the like. Although not shown, terminal 2 also includes a processor, memory, storage, communication module and display. This processor implements various processes by expanding the program memory stored in the storage and executing the program. This communication module is configured to allow two-way communication with the server 1. Each store can access the server 1 from the terminal 2 and update information in the store DB 133 and the coupon DB 134.

### Social Contribution Level DB

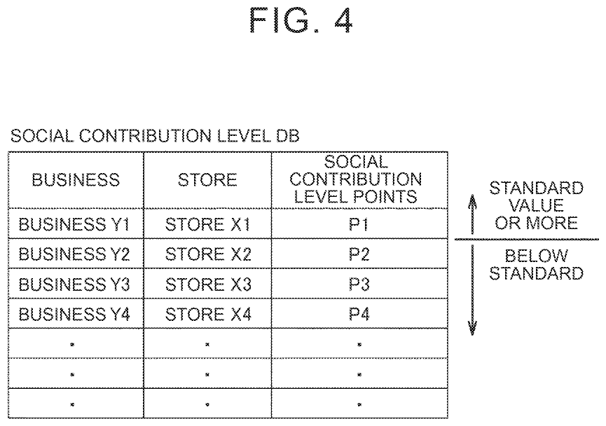

FIG. 4 is a diagram showing an example of the social contribution level DB 135. The social contribution level DB 135 records the social contribution level points of each business.

The social contribution level point is a value obtained by quantifying the social contribution of each business. The social contribution level point is a numerical value of social contribution activities such as the amount of CO2 reduction, the amount of donations to welfare facilities, disaster areas, etc., and the number of times of participation in volunteer activities.

For example, as shown in “social contribution level points=Coefficient K1×CO2 Reduction+Coefficient K2×Contribution Amount+ . . . ”, a value obtained by multiplying each of multiple items related to social contribution by a coefficient and summing them up is calculated as “social contribution level points”.

The server 1 automatically totals the social contribution level points and records the totalized result in the social contribution level DB 135. For example, the terminal 2 of each store or the terminal 2 installed in the business is installed with software for totalizing social contribution level points. For example, CO2 reduced by this software is measured and automatically aggregated. Also, the amount donated at each store is input from the terminal 2 and registered in this software.

The server 1 acquires the amount of CO2 reduction and the input amount of donation, etc., which are aggregated in the terminal 2, and calculates social contribution level points for each business. Then, the server 1 records the calculated social contribution level points in the social contribution level DB 135.

As shown in FIG. 4, the social contribution level DB 135 records the social contribution level points of businesses Y1 to Y4. Business Y1 operates store X1, and “P1” is set as the social contribution level point of business Y1. Business Y2 operates store X2, and “P2” is set as the social contribution level point of business Y2. Business Y3 operates store X3, and “P3” is set as the social contribution level point of business Y3. Business Y4 operates store X4, and “P4” is set as the social contribution level point of business Y4.

Businesses registered in the social contribution level DB 135 are the first business whose social contribution does not meet a predetermined standard (hereinafter referred to as a “non-contributing business”) and the second business (hereinafter referred to as “contributing business”) whose social contribution meets a predetermined standard.

Contributing businesses are recognized as businesses that actively contribute to society, such as reducing environmental impact, as typified by the activities of the Sustainable Development Goals (SDGs). Users who wish to actively contribute to society have a need to purchase products or services from stores operated by businesses (contributing businesses) with a high social contribution level.

Therefore, in the present embodiment, by displaying store information or coupon information of such contributing businesses in a form that emphasizes them, the user's purchasing from the contributing businesses is promoted, and the user's needs are met.

For example, the following multiple determination methods may be employed to determine whether the social contribution level reaches a predetermined standard. First, when the social contribution level point, which is a numerical value of the social contribution, is equal to or greater than the reference value PL, which is an absolute reference value, it is determined that the business is a contributing business whose social contribution reaches a predetermined standard. On the other hand, when the social contribution level point is less than the reference value PL, it is determined that the business is a non-contributing business whose social contribution does not reach the predetermined standard.

Secondly, it is determined whether the social contribution level has reached a predetermined standard based on the social contribution level point that quantifies the social contribution level and the category of the business. For example, if the category of the business is “restaurant”, the reference value is set to the reference value PL1, if the business type of the business is “store”, the reference value is set to the reference value PL2, and if the business type of the business is “hotel”, the reference value is set to be the reference value PL3.

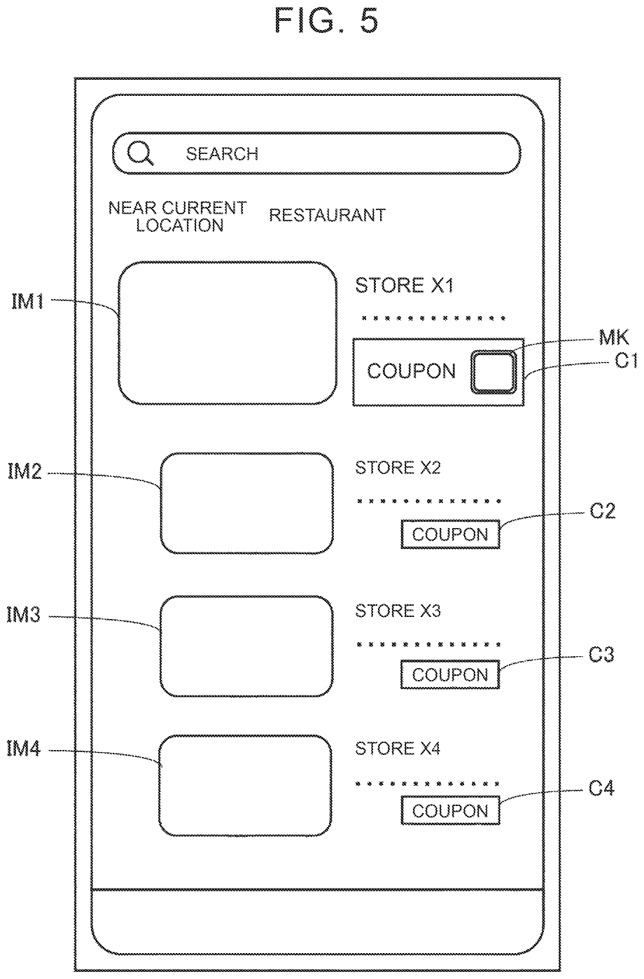

Alternatively, the condition for whether a predetermined criterion has been reached may be changed according to the search condition. For example, as will be described later with reference to FIG. 5, if the search conditions are “near current location” (B city, A prefecture) and “restaurant”, the top N stores with the highest social contribution level points among the stores that meet the search conditions (For example, 10 stores) may be determined to have reached a predetermined standard.

In the example of FIG. 4, when the social contribution level point P1 of the business Y1 is equal to or greater than the reference value, and the social contribution level points P2, 3, and 4 of the businesses Y2, 3, and 4 are respectively less than the reference value, the business Y1 contributes it is determined as a business, and businesses Y2, 3, and 4 are determined as non-contributing businesses.

In this embodiment, each business operates one store for the sake of simplicity, but each business may operate a plurality of stores. For example, when business Y4 operates three stores X41, 42, and 43, the three stores X41, 42, and 43 are recorded in the store column.

Although not shown, information on each store is recorded in the store DB 133. For example, it is the name of the business that manages each store, the type of store, the location of the store, an introductory text of the store, an introductory image of the store, and the like. The type of store indicates a category or a further subdivided category, such as a restaurant, a store, a rental car, and the like. Furthermore, the restaurant may be subdivided into categories such as Japanese cuisine and Western cuisine.

Although not shown, the coupon DB 134 records information on coupons that can be used at each store. For example, the discount amount or rate for food and drink at a restaurant, the period during which the coupon can be used, and the like. It should be noted that the resources for advertising expenses including these coupons may be borne by the businesses registered in the store DB 133.

### Display of store and Coupon Information

FIG. 5 is a diagram showing an example of a display form of the display 35 of the terminal 3. Store information and the like can be displayed on the display 35 by the user's operation on the terminal 3. The user can set search conditions or click a displayed link to display store information and the like.

In the example of FIG. 5, it is assumed that the user sets “near current location” and “restaurant” as search conditions to search for store information. Alternatively, you may click on the “Near Current Location” and “Restaurant” links displayed on the screen.

For example, the current position of the terminal 3 by the GPS 36 specifies that the user's current position is “B city, A prefecture”, and the server 1 acquires this information. The server 1 extracts from the store DB stores whose store type is “restaurant” and whose store location is “B city, A prefecture”.

It is assumed that stores X1 to X4 have been extracted as a group of stores that match the search conditions (hereinafter referred to as “matching store group”) by this search. The types of stores X1 to X4 are all “restaurants”, and the locations of the stores are “B city, A prefecture”.

As described with reference to FIG. 4, the social contribution level point P1 of business Y1 is greater than or equal to the reference value, and the social contribution level points P2, 3, and 4 of businesses Y2, 3, and 4 are less than the reference value, respectively.

Terminal 3 displays information of a first store (hereinafter referred to as “non-contributing store”) operated by a non-contributing business in a first form (hereinafter referred to as “normal form”), The information of the operated second store (hereinafter referred to as “contributing store”) is displayed in a second form (hereinafter referred to as “emphasis form”) that emphasizes more than the normal mode.

Store X1 of business Y1 is displayed in an emphasized form as a contributing store of the contributing business. On the other hand, store X2 of business Y2, store X3 of business Y3, and store X4 of business Y4 are displayed in a normal form as non-contributing stores of non-contributing businesses.

Specifically, the information of the contributing store X1 is displayed in the upper part of the screen, while the information of the non-contributing stores X2 to X4 is displayed in the lower part of the screen. Information on the store X1 is displayed in a large size, while information on the stores X2 to X4 is displayed in a smaller size than the information on the store X1.

In addition, the non-contributing store information includes a first coupon (hereinafter referred to as “normal coupon”) image that can be used at the non-contributing store. The information on the contributing store includes a second coupon (hereinafter referred to as “special coupon”) image that can be used at the contributing store.

In this case, the normal coupon image is displayed in a normal form without adding the mark image MK indicating that the social contribution level is high. On the other hand, the special coupon image is displayed in an emphasized form with the mark image MK added. In this example, the mark image MK is added to the coupon image C1 of the store X1 and displayed, while the mark image MK is not added to the coupon images C2 to C4 of the stores X2 to X4.

Information on stores X1 to X4 is displayed on the display 35 of the terminal 3 as information on “restaurants” in the “near present location”. Information on the store X1, which is a contributing store, is displayed at the top of the screen, and information on stores X2 to X4, which are non-contributing stores, is displayed at the top of the screen.

Information obtained from the store DB 133 is displayed as information on the store X1. On the screen, the store name “store X1” is displayed in large characters, and the image IM1 is displayed large as an introduction image of the store X1. Below the name of the store, an introductory text of the store and a coupon image C1 are displayed in a large size. Furthermore, a mark image MK indicating that the social contribution level is high is added to the coupon image C1.

Information on the store X2 is displayed below the information on the store X1. As the store X2, the store name “store X2”, the image IM2 as the introductory image of the store X2, the introductory text of the store X2 and the coupon image C2 are displayed. The store X2, the image IM2, the introductory text of the store X2, and the coupon image C2 are displayed smaller than the store X1, the image IM1, the introductory text of the store X2, and the coupon image C1, respectively. Also, the coupon image C2 does not have a mark image indicating that the social contribution level is high.

Information on stores X3 and X4 is displayed below the information on store X2. As the information of the store X3, the store X3, the image IM3, the introductory text of the store X3, and the coupon image C3 are displayed. As the information of the store X4, the store X4, the image IM4, the introductory text of the store X4, and the coupon image C4 are displayed. The size of the information on the stores X3 and X4 is the same as the size of the information on the store X2. The coupon images C3 and C4 do not have a mark image indicating that the social contribution level is high.

### Processing Flow

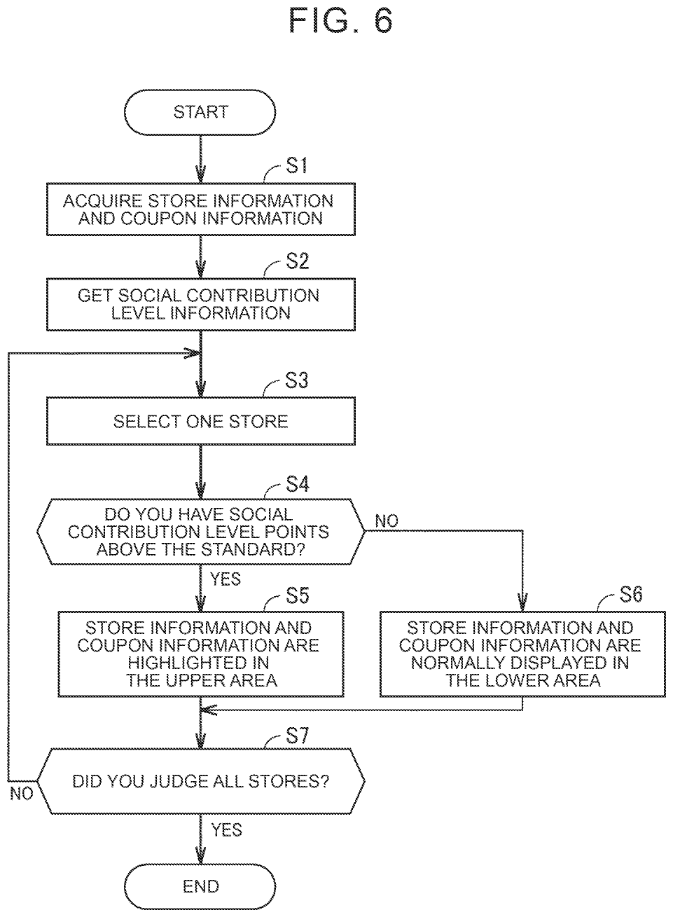

FIG. 6 is a flowchart showing an example of the processing procedure of display processing according to the present embodiment. The processing shown in this flowchart is executed when a user operation is performed to start displaying store and coupon information.

Each step is realized by software processing by the processor 31 of the terminal 3 (hereinafter simply referred to as “terminal 3”), but hardware (electric circuit, Large Scale Integration (LSI), etc.) arranged in the processor 31). Hereinafter, the step is abbreviated as S.

For example, it is assumed that the user operates the terminal 3 to set some search conditions and perform an operation to display store and coupon information. At this time, it is assumed that a group of stores matching the search condition (matching store group) has already been extracted. For example, in the example of FIG. 5, “stores X1 to X4” are extracted as matching stores using “near present location” (B city, A prefecture) and “restaurant” as search conditions.

In S1, the terminal 3 acquires store information and coupon information of the matching store group. The terminal 3 acquires the store information of the matching store group recorded in the store DB 133 and the coupon information of the matching store group recorded in the coupon DB 134 through communication with the server 1. In the above example, store information and coupon information for stores X1 to X4 as described above are acquired.

In S2, the terminal 3 acquires the social contribution level information of the business that operates each matching store group. The terminal 3 acquires the social contribution level information of the businesses operating each matching store group recorded in the social contribution level DB 135 through communication with the server 1. In the above example, social contribution level points P1 for business Y1 that operates store X1, social contribution level points P2 for business Y2 that operates store X2, social contribution level points P3 for business Y3 that operates store X3, and store X4. The social contribution level points P4 of the business Y4 are obtained.

In S3, the terminal 3 selects one store. For example, in the above example, the store X1 is selected from the extracted stores X1 to X4.

In S4, the terminal 3 determines whether the social contribution level points of the business that manages the selected store are equal to or greater than a reference value. More specifically, for example, one of the multiple determination methods described with reference to FIG. 4 is adopted. In the above example, P1 at store X1 is determined to be greater than or equal to the reference value, and P2 at store X2, P3 at store X3, and P5 at store X4 are determined to be less than the reference value.

If the social contribution level points of the business that operates the selected store is equal to or higher than the reference value (YES in S4), the terminal 3 highlights the store information and coupon information of the selected store in the upper area (S5). As described with reference to FIG. 5, store information and coupon information for store X1 are highlighted in the upper area.

If the social contribution level points of the business that manages the selected store is less than the reference value (NO in S4), the terminal 3 normally displays the store information and coupon information of the selected store in the lower area (S6). As described with reference to FIG. 5, when the selected stores are stores X2 to X4, store information and coupon information are normally displayed in the lower area.

If the terminal 3 has determined for all stores (YES in S7), it ends this process. On the other hand, if the terminal 3 has not determined for all stores (NO in S7), the process returns to S3. As a result, the processes from S4 to S6 are executed for all the stores in the matched store group. For example, if the matching store group consists of stores X1 to X4, the processes from S4 to S6 are executed in the order of X1, X2, X3, and X4.

As described above, in the present embodiment, the business includes the first business (non-contributing business) determined that the social contribution level does not reach the predetermined standard, and the second business (contributing business) determined that the social contribution level reaches the predetermined standard. The processor 31 displays information of a first store (non-contributing store) operated by a non-contributing business in a first form (normal form), and displays information of a second store (contributing store) operated by a contributing business. The display 35 is controlled so as to display information in a second form (emphasis form) that emphasizes information more than the normal mode.

In this way, since the information of the contributing stores operated by the contributing businesses is displayed in a form that emphasizes the information of the non-contributing businesses operated by the non-contributing businesses, the user can more easily obtain the information of the contributing stores. Thus, the needs of users who want to actively use stores operated by businesses with a high social contribution level can be met.

The non-contributing store information includes a first coupon (ordinary coupon) image that can be used at the non-contributing store. The contributing store information includes a second coupon (special coupon) image that can be used at the contributing store. Coupons that can be used at contributing stores are highlighted and displayed, so that users can use the coupons to meet the needs of users who want to actively use stores operated by businesses with high social contribution level.

The normal form is a form in which the mark image MK indicating that the social contribution level is high is not added to the normal coupon image. The emphasis form is a form in which a mark image is added to the special coupon image. Thus, by looking at the coupon, it is possible to identify whether the store is operated by a business that makes a high social contribution level.

Whether the social contribution level has reached a predetermined standard is determined based on the quantified value of the social contribution level and the category of the business. As a result, it is possible to change the criteria for whether a business makes a high social contribution level for each category.

The processor 31 causes the display 35 to display the information of the contributing stores at a first position (upper portion of the screen) and the information of the non-contributing stores at a second position (lower portion of the screen) below the first position. Control. This increases the probability that the user will purchase from the contributing store. Thus, the needs of users who want to actively use stores operated by businesses with a high social contribution level can be met.

When the numerical value of the social contribution level exceeds a predetermined reference value (absolute value), it is determined that the social contribution level has reached a predetermined reference. As a result, it is possible to calculate the social contribution level based on a standardized absolute standard.

In the present embodiment, the terminal 3 has been described as an example of the “information equipment” of the present disclosure, but the server 1 and the display are not limited to this, and may correspond to an example of the “information equipment” of the present disclosure. This display may be connected to the server 1 or may be provided in a terminal that communicates with the server 1. In this case, the server 1 generates image information to be displayed on the display.

The embodiments disclosed this time should be considered to be illustrative in all respects and not restrictive. The scope of the present disclosure is indicated by the scope of the claims rather than the description of the above-described embodiments, and is intended to include all modifications within the scope and meaning equivalent to the scope of the claims.

What is claimed is:

1. Information equipment, comprising:
a display configured to display information of a store operated by a business; and
a control device that controls the display, wherein the control device controls the display to display information of a first store operated by a first business of which a social contribution level has been determined not to attain a predetermined standard in a first form, and to display information of a second store operated by a second business of which the social contribution level has been determined to attain the predetermined standard in a second form that is more emphasized than the first form.

2. The information equipment according to claim 1, wherein
the information of the first store includes a first coupon image that can be used at the first store, and
the information of the second store includes a second coupon image that can be used at the second store.

3. The information equipment according to claim 2, wherein
the first form is a form in which a mark image, indicating that the social contribution level is high, is not added to the first coupon image, and
the second form is a form in which the mark image is added to the second coupon image.

4. The information equipment according to claim 1, wherein determination of whether the social contribution level attains the predetermined standard is made based on a numerical value obtained by quantizing the social contribution level, and a category of the business.

5. A method for displaying information of a store operated by a business, the method comprising displaying the information of the store on a display of information equipment, wherein the displaying includes displaying information of a first store operated by a first business of which a social contribution level has been determined not to attain a predetermined standard in a first form, and displaying information of a second store operated by a second business of which the social contribution level has been determined to attain the predetermined standard in a second form that is more emphasized than the first form.
